(19) United States
(12) Patent Application Publication
(10) Pub. No.: US 2009/0256810 A1
(43) Pub. Date: Oct. 15, 2009

(54) TOUCH SCREEN DISPLAY

(75) Inventor: Donato PASQUARIELLO, Vasteras (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/103,223

(22) Filed: Apr. 15, 2008

(51) Int. Cl. G06F 3/041

(52) U.S. Cl. 345/173

(57) ABSTRACT

A device may include a number of diodes and control logic. The control logic may be configured to forward bias a first one of the diodes for a first duration of time corresponding to a frame, forward bias a second one of the diodes for a first portion of the frame, and reverse bias the second diode for a second portion of the frame. The second diode functions as an input or touch detector during the second portion of the frame.

### TECHNICAL FIELD OF THE INVENTION

The invention relates generally to displays and, more particularly, to touch screen displays.

### DESCRIPTION OF RELATED ART

Currently, most touch screens used in electronic devices for user input are resistive touch screens. Resistive touch screens may be applied to many types of displays and are relatively inexpensive. A drawback with resistive touch screens is that the resistive touch screen is applied to the front of the display. This reduces the front-of-screen performance since the resistive touch screen components/layers are placed in front of the display. These added components/layers reduce the brightness of the display.

Another drawback with resistive touch screens is that the overall thickness of the display is increased. That is, the additional components/layers, such as additional glass plates, needed in front of the display increase the thickness of the display. Further, resistive touch screens are prone to mechanical damage and fatigue, which can result in sensor drift and may shorten the useful life of the touch screen. Sensor drift may require that the touch screen be periodically calibrated, which may reduce the user's satisfaction level with the touch screen.

### SUMMARY

According to one aspect, a device is provided. The device includes a display comprising a plurality of diodes and logic. The logic is configured to forward bias a first one of the diodes for a first duration of time, the first duration of time corresponding to a frame, forward bias a second one of the diodes for a first portion of the frame, and reverse bias the second diode for a second portion of the frame, the second diode functioning as a touch detector during the second portion of the frame.

Additionally, the logic may be further configured to receive, during the second portion of the frame, a current or voltage associated with the second diode, and determine that a touch occurred based on the received current or voltage.

Additionally, the logic may be further configured to determine a location on the display or a display element associated with the touch, and process the input based on the location or display element.

Additionally, when forward biasing the first and second diodes, the logic may be further configured to provide a first driving voltage to the first diode during the first duration of time, and provide a second driving voltage to the second diode during the first portion of the frame, the second driving voltage being based on the relative duration of the first portion of the frame with respect to the second portion of the frame.

Additionally, when forward biasing the first and second diodes, the logic may be further configured to provide a greater driving voltage to the second diode during the first portion of the frame than a driving voltage provided to the first diode during the first portion of the frame.

Additionally, the logic may be further configured to detect multiple touches on the display that occur simultaneously or substantially simultaneously based on a received current or voltage associated with multiple ones of the plurality of diodes.

Additionally, the first diode and second diodes may be associated with a single pixel of the display and wherein the first diode may be configured to emit light have a first wavelength or range of wavelengths and the second diode may be configured to detect light having the first wavelength or range of wavelengths.

Additionally, the first diode may be a blue diode and the second diode may be a green diode or red diode, the blue diode including a modulator configured to modulate emitted blue light to have a first frequency, and wherein the second diode is a red or green diode configured to detect blue light having the first frequency.

Additionally, the device may further comprise optical shielding disposed between at least the first and second diodes, the optical shielding preventing light emitted from the first diode from being directly received by the second diode.

Additionally, the plurality of diodes may comprise organic light emitting diodes or polymer light emitting diodes.

Additionally, the device may comprise a mobile telephone.

According to another aspect, in a device comprising a display, a method is provided. The method comprises forward biasing a first one of a plurality of diodes associated with a first pixel in the display for a first duration of time and forward biasing a second one of the diodes associated with the first pixel in the display for a second duration of time, the second duration of time being less than the first duration of time. The method also includes reverse biasing the second diode for a third duration of time, the third duration of time overlapping with the first duration of time and detecting light by the second diode during the third duration of time. The method further includes determining that a touch on the display occurred based on the detected light.

Additionally, the method may comprise converting, by the second diode, the detected light into a current or voltage and the determining that a touch occurred may comprise determining that the touch occurred when the current or voltage is greater than a threshold.

Additionally, the method may further comprise determining a location on the display or a display element associated with the touch and processing the touch based on the location or display element.

Additionally, the forward biasing the second diode may comprise forward biasing the second diode with a driving voltage based on the relative duration of the second duration of time with respect to the first duration of time.

Additionally, the forward biasing the first diode may comprise forward biasing the first diode with a first voltage, and the forwarding biasing the second diode may comprise forward biasing the second diode with a second voltage, the second voltage being greater than the first voltage.

Additionally, the second voltage may range from 10 percent to 50 percent greater than the first voltage, the particular percentage being based on the relative duration of the second duration of time with respect to the third duration of time.

Additionally, the method may further comprise modulating light emitted from the first diode to a first frequency, and wherein the detecting light by the second diode may comprise detecting light having the first frequency.

Additionally, the method may further comprise providing optical shielding between at least the first and second diodes, the optical shielding preventing light emitted from the first diode from being directly received by the second diode.

Additionally, the method may further comprise detecting multiple touches on the display that occur simultaneously or substantially simultaneously based on a current or voltage associated with multiple ones of the plurality of diodes.

Additionally, the second duration of time may be greater than or equal to the third duration of time.

According to still another aspect, a device comprises display means comprising a first plurality of light emitting components and a second plurality of light emitting components, at least some of the second light emitting components functioning as both light emitting components and light detecting components. The device also includes control means for forwarding biasing at least some of the first plurality of light emitting components for a first period of time, forward biasing at least some of the second plurality of light emitting components for a second period of time and reverse biasing the at least some of the second plurality of light emitting components for a third period of time, the third period of time overlapping with the first period of time. The device further includes input detection means for detecting a touch on the display means based on a current or voltage detected during the third period of time.

Additionally, the control means may be configured to forward bias the at least some of the second plurality of light emitting components with a higher driving voltage than the at least some of the first light emitting components, the higher driving voltage being based on a duration of the second period of time.

Additionally, the device may further comprise modulator means for modulating light emitted from the first plurality of light emitting components to a first frequency, the second plurality of light emitting components being configured to detect light having the first frequency.

### BRIEF DESCRIPTION OF THE DRAWINGS

Reference is made to the attached drawings, wherein elements having the same reference number designation may represent like elements throughout.

FIG. 1 is a diagram of an exemplary mobile terminal in which methods and systems described herein may be implemented;

FIG. 2 is a diagram illustrating components of the mobile terminal of FIG. 1 according to an exemplary implementation;

FIG. 3 illustrates exemplary components of the mobile terminal of FIG. 2 according to an exemplary implementation;

FIG. 4 is a diagram illustrating portions of the display of FIG. 3 according to an exemplary implementation;

FIGS. 5A and 5B are diagrams illustrating the forward and reverse biasing of a diode of FIG. 4 according to an exemplary implementation;

FIGS. 6A and 6B are timing diagrams illustrating durations for forward and reverse biasing diodes in the display of FIG. 4 according to an exemplary implementation;

FIG. 7 schematically illustrates a portion of the display of FIG. 1 according to an exemplary implementation;

FIG. 8 is a flow diagram illustrating processing by a mobile terminal according to an exemplary implementation; and

FIG. 9 is a diagram schematically illustrating a touch on the display of FIG. 7 according to an exemplary implementation.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

Exemplary implementations of the invention will be described in the context of a mobile communication device. It should be understood that a mobile communication device is an example of a device that can employ a display consistent with the principles described herein and should not be construed as limiting the types or sizes of devices or applications that include displays described herein. For example, displays consistent with the principles described herein may be used on a desktop device (e.g., a personal computer or workstation), a laptop computer, a personal digital assistant (PDA), a media playing device (e.g., an MPEG audio layer 3 (MP3) player, a digital video disc (DVD) player, a video game playing device), a household appliance (e.g., a microwave oven and/or appliance remote control), an automobile radio faceplate, a television, a computer screen, an industrial device (e.g., test equipment, control equipment) or any other device that includes a display.

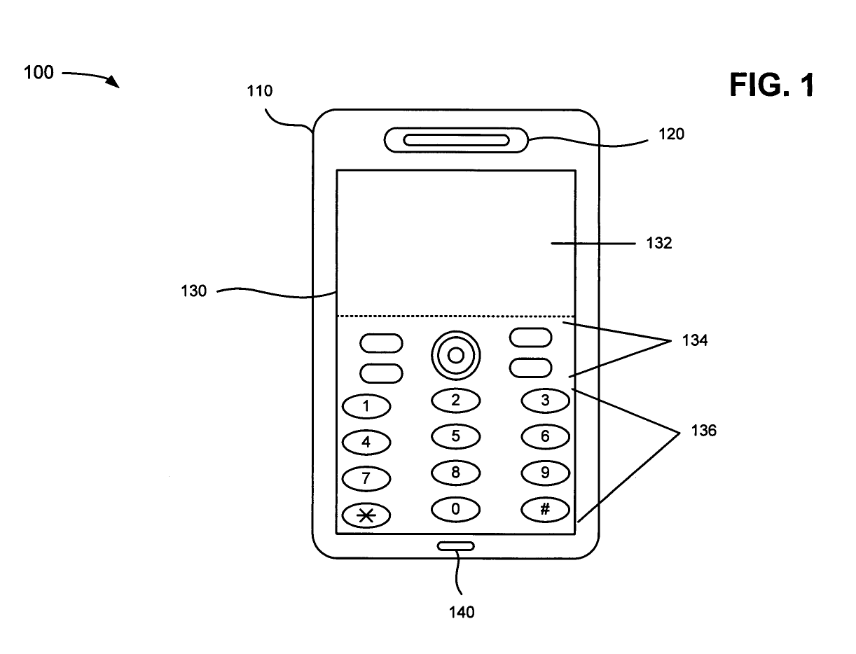

FIG. 1 is a diagram of an exemplary mobile terminal 100 in which methods and systems described herein may be implemented. As used herein, the term “mobile terminal” may include a cellular radiotelephone with or without a multi-line display; a Personal Communications System (PCS) terminal that may combine a cellular radiotelephone with data processing, facsimile and data communications capabilities; a PDA that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. Mobile terminal 100 may also include media playing capability. As described above, it should also be understood that systems and methods described herein may also be implemented in other devices that include displays, with or without including various other communication functionality.

Referring to FIG. 1, mobile terminal 100 may include a housing 110, a speaker 120, a display 130 and a microphone 140. Housing 110 may protect the components of mobile terminal 100 from outside elements. Speaker 120 may provide audible information to a user of mobile terminal 100. Microphone 140 may receive audible information from the user.

Display 130 may include an upper display area 132 (referred to herein as upper display 132) that provides visual information to the user. For example, upper display 132 may include the area located above the dotted line shown in FIG. 1 and may provide information regarding incoming or outgoing telephone calls and/or incoming or outgoing electronic mail (e-mail), instant messages, short message service (SMS) messages, etc. Upper display 132 may also display information regarding various applications, such as a phone book/contact list stored in mobile terminal 100, a telephone number, the current time, video games being played by a user, downloaded content (e.g., news or other information), etc.

Control buttons 134 may permit the user to interact with mobile terminal 100 to cause mobile terminal 100 to perform one or more operations, such as place a telephone call, play various media, etc. For example, control buttons 134 may include a dial button, hang up button, play button, etc. Keypad 136 may include a telephone keypad used to input information in mobile terminal 100.

In an exemplary implementation, display 130 may be operate as both an emissive display used to display information to a user and as a touch screen used to receive input from the user. In one implementation, display 130 may include a light emitting diode (LED) based display, such as an organic LED (OLED) based display, a polymer LED (poly-LED) based display or another type of LED display. In each case, various elements (e.g., LEDs and/or sub-pixels) of display 130 may function as both emitters and detectors of light to enable display 130 to operate as a touch screen display. The emitter/detector functionality of the LEDs/sub-pixels may be controlled based on power applied to various LEDs/sub-pixels of display 130, as described in detail below.

In an exemplary implementation, control buttons 134 and keypad 136 may be part of display 130. That is, upper display 132, control buttons 134 and keypad 136 may be provided via an LED-based display that may operate as both an emissive display and a touch screen display. In addition, in some implementations, different control buttons and keypad elements may be provided based on the particular mode in which mobile terminal 100 is operating. For example, when operating in a cell phone mode, a conventional telephone keypad may be displayed in area 136 and control buttons associated with dialing, hanging up, etc., may be displayed in area 134. When operating as a music playing device, control buttons and keypad elements associated with playing music may be displayed in areas 134 and 136. In each situation, a user may select a particular input by touching a particular part of display 130 and mobile terminal 100 may detect the particular input, as described in more detail below.

In other implementations, control buttons 134 and/or keypad 136 may not be part of display 130 and may include conventional input devices used to input information to mobile terminal 100. In such implementations, upper display 132 may operate as an emissive display and a touch screen display. In these implementations, control buttons 134 may include one or more buttons that controls various settings associated with display 130. For example, one of control buttons 134 may be used to toggle between operating upper display 132 as a conventional display (e.g., without touch screen capability) and operating upper display 132 as a touch screen display. Further, one of control buttons 134 may be a menu button that permits the user to view various settings associated with mobile terminal 100. Using the menu, a user may also be able to toggle upper display 132 between a conventional display and a touch screen display.

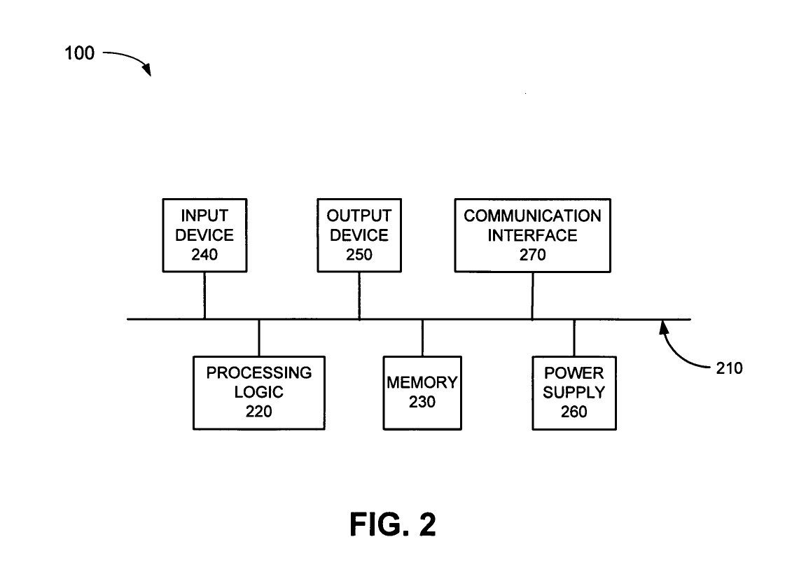

FIG. 2 is a diagram illustrating components of mobile terminal 100 according to an exemplary implementation. Mobile terminal 100 may include bus 210, processing logic 220, memory 230, input device 240, output device 250, power supply 260 and communication interface 270. Bus 210 permits communication among the components of mobile terminal 100. One skilled in the art would recognize that mobile terminal 100 may be configured in a number of other ways and may include other or different elements. For example, mobile terminal 100 may include one or more modulators, demodulators, encoders, decoders, etc., for processing data.

Processing logic 220 may include a processor, microprocessor, an application specific integrated circuit (ASIC), field programmable gate array (FPGA) or the like. Processing logic 220 may execute software instructions/programs or data structures to control operation of mobile terminal 100.

Memory 230 may include a random access memory (RAM) or another type of dynamic storage device that stores information and instructions for execution by processing logic 220; a read only memory (ROM) or another type of static storage device that stores static information and instructions for use by processing logic 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may include one or more memory devices and/or carrier waves.

Input device 240 may include mechanisms that permit an operator to input information to mobile terminal 100, such as display 130, microphone 140, a keyboard, a mouse, a pen, voice recognition and/or biometric mechanisms, etc. For example, as discussed above, all or a portion of display 130 may function as a touch screen input device for inputting information to mobile terminal 100.

Output device 250 may include one or more mechanisms that output information to the user, including a display, such as display 130, a printer, one or more speakers, such as speaker 120, etc. Power supply 260 may include one or more batteries or other power source components components used to supply power to components of mobile terminal 100. Power supply 260 may also include control logic to control application of power from power supply 260 to one or more components of mobile terminal 100.

Communication interface 270 may include any transceiver-like mechanism that enables mobile terminal 100 to communicate with other devices and/or systems. For example, communication interface 270 may include a modem or an Ethernet interface to a LAN. Communication interface 270 may also include mechanisms for communicating via a network, such as a wireless network. For example, communication interface 270 may include one or more radio frequency (RF) transmitters, receivers and/or transceivers. Communication interface 270 may also include one or more antennas for transmitting and receiving RF data.

Mobile terminal 100 may provide a platform for a user to make and receive telephone calls, send and receive electronic mail, text messages, play various media, such as music files, video files, multi-media files, games, and execute various other applications. Mobile terminal 100 may also perform processing associated with display 130 operating as a touch screen input device. Mobile terminal 100 may perform these operations in response to processing logic 220 executing sequences of instructions contained in a computer-readable medium, such as memory 230. Such instructions may be read into memory 230 from another computer-readable medium via, for example, communication interface 270. A computer-readable medium may include one or more memory devices and/or carrier waves. In alternative embodiments, hard-wired circuitry may be used in place of or in combination with software instructions to implement processes consistent with the invention. Thus, implementations described herein are not limited to any specific combination of hardware circuitry and software.

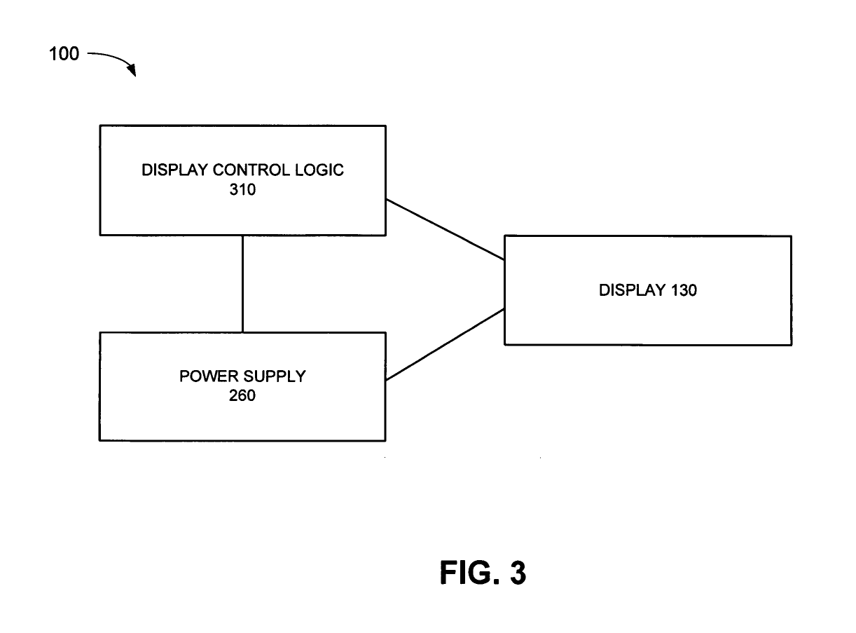

FIG. 3 is a functional diagram of components implemented in mobile terminal 100. Referring to FIG. 3, mobile terminal 100 may include display control logic 310, power supply 260 and display 130. Display control logic 310 may be included in processing logic 220.

Display control logic 310 may provide power or signal power supply 260 to forward bias or reverse bias LEDs of display 130 to allow display 130 to operate as a touch sensitive display device. For example, in one implementation, display control logic 310 may forward bias one or more LEDs of display 130 during a first portion of time associated with a frame and reverse bias the same one or more LEDs during a second portion of the frame. While forward biased, the LED functions as a conventional LED that emits light associated with one of the pixels of display 130 and enables display 130 to operate as an output or display device. When reversed biased, the LED functions as a photodiode or detector of light and enables display 130 to operate as a touch screen device, as described in detail below.

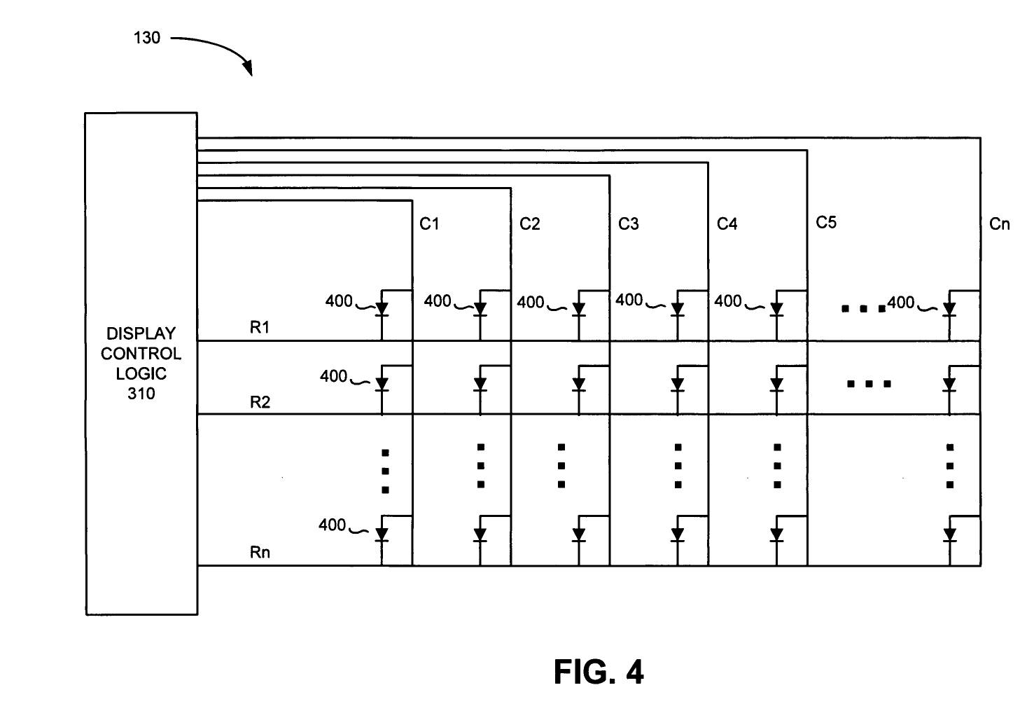

In an exemplary implementation, display 130 may include a number of LEDs organized, for example, in a matrix of rows and columns. For example, referring to FIG. 4, display 130 may include a number of LEDs 400 arranged in rows R1-Rn and columns C1-Cn. Display control logic 310 may provide power to LEDs 400 on a row-by-row basis or column-by-column basis using row drivers and/or column drivers (not shown in FIG. 4 for simplicity). Other configurations of LEDs may also be used.

An individual pixel can be lit by applying a positive voltage to one or more columns of LEDs corresponding to the pixel and grounding the row associated with the one or more LED(s). In addition, to provide visual elements on display 130, the LEDs in various columns that will be used to display information may be biased with a positive voltage for a predetermined duration or frame time, while the row is grounded. Display control logic 310 may then perform the same procedure for the next row of the display (e.g., ground the row and positively bias the appropriate columns) and continue this procedure for each row. When the last row is reached, display control logic 310 returns to the first row of display 130 and continues the process. Performing this row-by-row process quickly enough provides a display that appears steady to the human eye.

In an exemplary implementation, display 130 may be a color display, such as a red, green, blue (RGB) display. In this implementation, three diodes 400 may form a single pixel of display 130. For example, a red diode, a green diode and a blue diode that emit red, green and blue light, respectively, when the diode is forward biased with a predetermined voltage may be combined to display a single pixel of information on display 130.

The individual diodes 400, also referred to as sub-pixels, may also be reversed biased for a duration of a frame. When a diode or sub-pixel is reversed biased, that diode acts as photodiode. That is, the diode 400 functions as a detector of light, as opposed to an emitter of light. In implementations described herein, when a user's finger or stylus nears or touches the upper surface of display 130, light from diodes 400, acting as emitters of light, is reflected from the user's finger or stylus. Some of the reflected light may be detected by one or more of diodes 400 acting as detectors of light. Display control logic 310 may receive information, such as an electrical current or voltage, indicating that a particular diode 400 detected light. This information may then be correlated to a signal indicating that a user pressed or touched a particular portion of display 130 (i.e., intended to enter an input). The electrical current (or voltage) needed to generate a signal may be set to a predetermined threshold to reduce or eliminate false or incidental touches, as described in detail below.

In an exemplary implementation, a diode that emits light may also detect light having a wavelength less than or equal to the light that it emitted. For example, a blue diode 400 that emits light in the blue wavelength range may also detect light having a wavelength of less than the blue range, a green diode 400 that emits light in the green wavelength range may also detect light having a wavelength of less than the green range and a red diode 400 that emits light in the red wavelength range may also detect light having a wavelength of less than the red range. In some implementations, it may be possible for a blue diode 400 to detect blue light reflected back from a blue diode 400 in display 130. However, in an exemplary implementation, to enhance the sensitivity of display 130 with respect to detecting a touch/input, red or green diodes may be used as light detectors to detect blue light. That is, the red or green diodes may have a higher sensitivity in detecting longer wavelengths than the blue diodes. For example, in an RGB display, the red diodes may have a higher sensitivity to detecting blue and green light than the other diodes. However, in an exemplary implementation described below, green diodes 400 may be used to detect blue light.

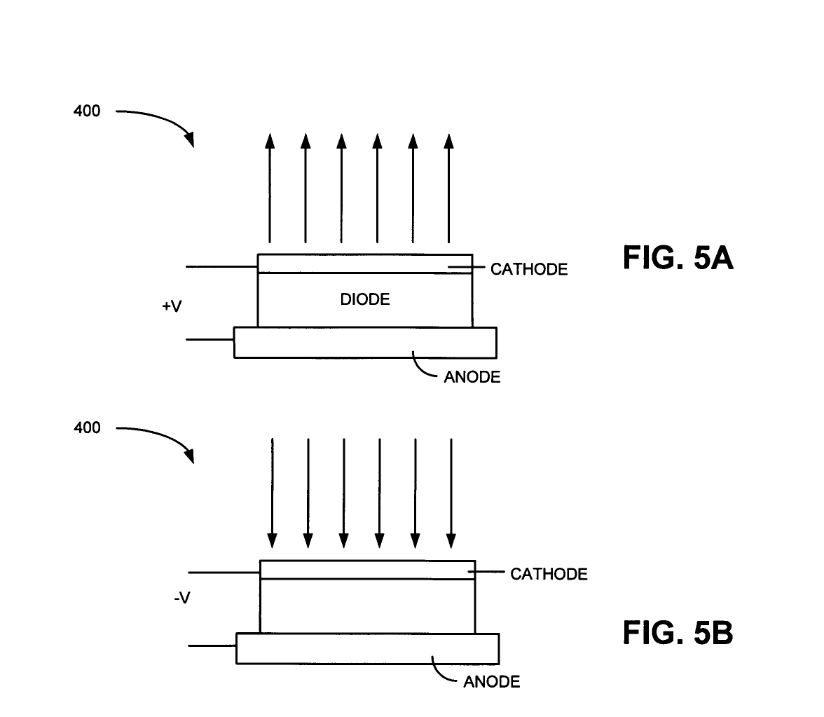

As discussed above, when diodes 400 in display 130 are forward biased, the diodes 400 act as emitters of light. For example, FIG. 5A illustrates diode 400 in a forward biased configuration. That is, a positive voltage of +V (e.g., 5 volts) is applied from the cathode to the anode of diode 400. In this case, diode 400 emits light, as illustrated by the arrows in FIG. 5A. In this implementation, diode 400 may be an OLED in which the cathode may be an optically transparent conductor, such as, for example, as indium tin oxide (ITO) layer. Using a transparent conductor allows the light from diode 400 to be emitted through the surface of display 130 without, for example, significant attenuation or distortion.

When diode 400 is reverse biased with a negative voltage −V (e.g., −5 volts) applied from the cathode to the anode, as illustrated in FIG. 5B, diode 400 acts as a photodiode. That is, diode 400 may be used to detect incoming light, as illustrated by the arrows in FIG. 5B, and no longer emits light.

Display control logic 310 may forward and reverse bias various diodes 400 of display 130 for a portion of a frame time to allow display 130 to act as both an emissive display and a touch screen. For example, in a conventional LED based display, when an image is to be displayed, a drive voltage may be asserted for one or more columns (or rows) of LEDs for a predetermined duration, referred to herein as a frame time or frame period, followed by a similar procedure for succeeding rows in the display. During this frame time, the diodes in the column that are forward biased emit light. In an exemplary implementation, display control logic 310 may provide the drive voltage to a column of diodes for only a predetermined duration of the frame time and reverse bias one or more of the same diodes during another portion of the frame time. This enables a number of diodes to function as both emitters of light and detectors of light.

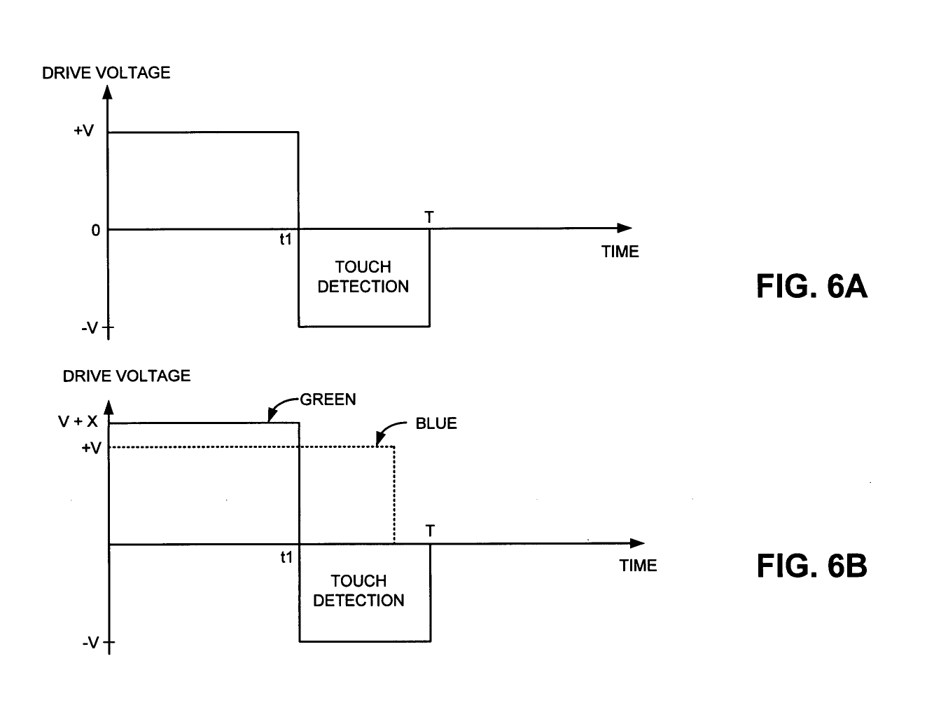

As an example, assume that a frame time has a duration of T, as illustrated in FIG. 6A. As further shown in FIG. 6A, display control logic 310 may exert a drive voltage of +V on an LED 400 (or a column of LEDs 400) during a first portion of frame T (i.e., up to time t1). At time t1, display control logic 310 may reverse bias the diode 400 with a voltage of −V. During the period of time that the diode 400 is reverse biased (i.e., from t1 to T, labeled “touch detection” in FIG. 6A), the diode 400 may function as a photodiode to detect light reflected off of, for example, a user's finger or stylus. Display control logic 310 may then determine a location on display 130 where the touch occurred and input this information to, for example, processing logic 220 for further processing.

In some instances, to compensate for potential loss of brightness associated with the diodes being used as touch detectors, display control logic 310 may provide a higher driving voltage for those diodes during the portion of the frame in which the diodes are forward biased (operating as emitters). For example, FIG. 6B illustrates a scenario in which the green diodes 400 are to be used to detect light emitted from the blue diodes 400 and reflected back. In this case, the green diodes 400 may be provided with a higher driving voltage than the blue diodes 400 (i.e., a voltage of V+X, where X is some predetermined amount) during the portion of the frame from 0 to time t1. In an exemplary implementation, the higher driving voltage for the green diodes 400 may range from, for example, 10-50% higher (or more, such as 100% higher) than the driving voltage for the blue diodes 400. This higher driving voltage may compensate for any loss of brightness during the period of time when the green diodes 400 are no longer emitting light and are functioning as light/touch detectors (e.g., from time t1 to T).

In addition, in some implementations, the longer the duration of time in which the green diodes 400 are acting to detect light (e.g., from time t1 to T illustrated as touch detection in FIG. 6B), the greater the driving voltage for the green diodes 400 during time 0 to t1. In other words, the longer the duration of the touch detection period (i.e., the time from t1 to T) for green diodes 400, the greater the value X in FIG. 6B. For example, the increase or difference in driving voltage of the green diodes 400 relative to the driving voltage of blue diodes 400 may be larger in instances where the first portion of the frame time from 0 to t1 is shorter relative to frame time T than in instances when the first portion of frame time from 0 to t1 is longer relative to frame time T.

In other implementations, the driving voltage for the green diodes 400 may be independent of the driving voltage of the other diodes, such as blue diodes 400, but may be based on the relative duration of the first portion of the frame from time 0 to t1 with respect to the second portion of the frame from time t1 to T. In such instances, the actual driving voltage of the green diodes 400 may be less than, equal to or greater than the driving voltage of other diodes 400, such as blue diodes 400. However, the driving voltage may be based on the duration of the first portion of the frame and/or the relative duration of the first portion of the frame with respect to the total duration of the frame. The actual driving voltage may also be selected to achieve good overall output for display 130, while also minimizing power consumption of display 130.

In FIG. 6B, the duration of the touch detection period (i.e., from t1 to T) is shown as extending beyond the period in which the blue diode 400 is forward biased. In other implementations, the blue diode 400 may be forward biased up through time T. In addition, the period of time during which the green diode 400 is forward biased may be longer than the period of time during which the green diode 400 is reverse biased. For example, in one implementation, the period of time from 0 to t1 may range from 50% to 80% of the total frame time T. This may enable the green diodes 400 to emit adequate light during the frame period when operating as an emitter and still provide adequate time to act as a detector of light. Further, as discussed above, the driving voltage of the green diodes 400 may be based on the duration of time from 0 to t1 with respect to the duration of time from t1 to T, to compensate for any loss of brightness when the green diodes 400 are functioning as light/touch detectors.

In some instances, various diodes 400 of display 130 may receive cross-talk from neighboring diodes 400. That is, a diode 400 operating as a detector of light (i.e., is reverse biased) may receive light that is emitted from a neighboring diode 400, as opposed to light reflected back from a user's finger or stylus contacting display 130. This may make it more difficult for display control logic 310 to detect an actual touch, as opposed to cross-talk. To eliminate or reduce this problem, display 130 may include optical shielding between various diodes 400.

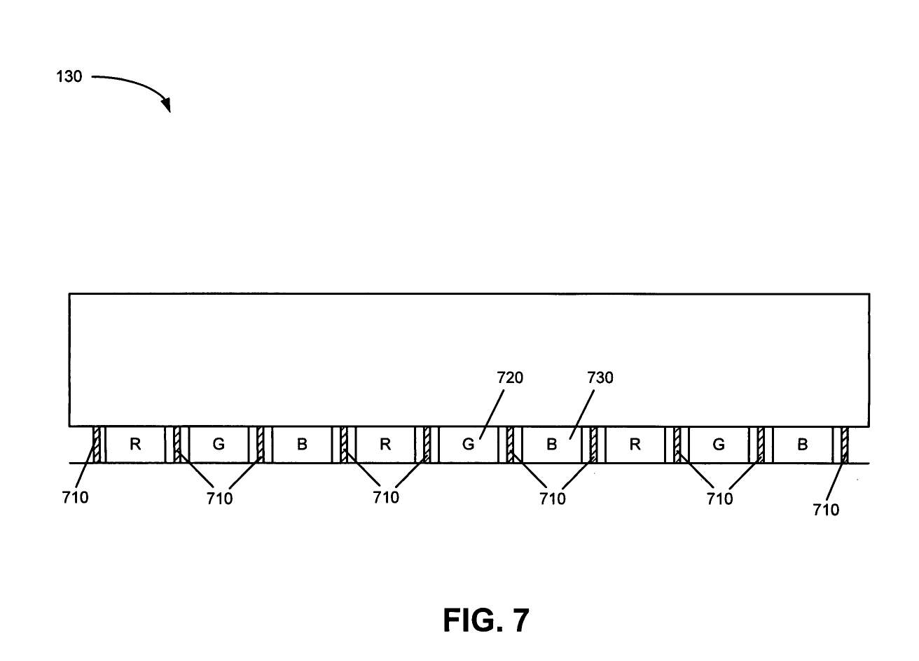

For example, FIG. 7 schematically illustrates a portion of display 130 according to an exemplary implementation. Referring to FIG. 7, display 130 may include red, green and blue diodes/sub-pixels (labeled R, G and B, respectively) associated with an RGB display. To avoid cross-talk between neighboring diodes 400, optical shielding 710 may be used to separate the R, G and B diodes. The optical shielding 710 may include any number of materials or structures that are opaque to light and/or reflect light and that substantially prevent neighboring diodes from interfering with an adjacent diode that is operating as a photodiode.

For example, referring to FIG. 7, rectangular or cylindrical structures 710 may be formed between the R, G and B diodes. Structures 710 may act to block or reflect light and substantially inhibit light from passing to a neighboring diode. As an example, structure 710 formed between green diode 720 and blue diode 730 prevents light from blue diode 730 from being directly received by green diode 720. That is, light from blue diode 730 will not penetrate optical shielding 710. However, light from blue diode 730 may be indirectly received by green diode 720 via a reflection from a user's finger or stylus, as described in more detail below. In this manner, light emitted from blue diode 730 will not be directly detected by neighboring green diode 720 and incorrectly interpreted by display control logic 310 as an input/touch. This helps prevent false touch indications with respect to display 130. Although optical shielding 710 is illustrated as being formed between all of the diodes in FIG. 7, in some implementations, only the diodes acting as touch detectors may require optical shielding between themselves and adjacent diodes. For example, if green diodes are acting as touch detectors, optical shielding 710 may be located between the green diodes and adjacent blue diodes.

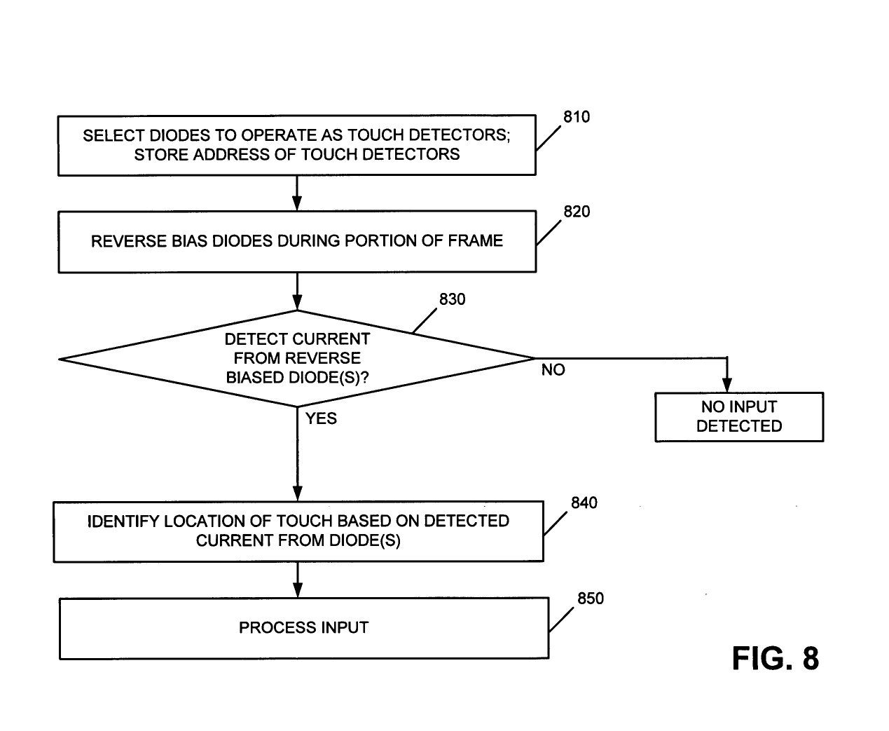

FIG. 8 is a flow diagram illustrating processing by mobile terminal 100 in an exemplary implementation. Processing may begin when mobile terminal 100 powers up. Display control logic 310 may provide power to display 130. As discussed above with respect to FIGS. 6A and 6B, display control logic 310 may forward bias various diodes 400 (or columns of diodes) to emit light visible to the user. For example, if display 130 is being used to display various visual elements, the appropriate columns of the diodes 400 corresponding to these visual elements may be driven with a supply voltage on a row-by-row basis. As also described with respect to FIGS. 6A and 6B, display control logic 310 may reverse bias some of the diodes 400 being used to display the visual elements for a portion of a frame time so that these diodes 400 operate as touch detectors.

In an exemplary implementation, various diodes or sub-pixels are selected to be used as both emitters of light and touch detectors (act 810). In this example, assume that all or a portion of the green diodes are selected to operate as touch detectors. This selection may take place at the time of fabrication of mobile terminal 100 and/or display 130. Display control logic 310 may store the address (i.e., column and row address) of each of the green diodes 400 in memory, such as memory 230 (act 810).

Display control logic 310 may then forward bias the red, green and blue diodes 400 corresponding to a pixel on display 130 when visual information is to be presented for that pixel. Display control logic 310 may also provide a negative bias to the green diodes 400 for a portion of the frame in which the corresponding red and blue diodes 400 associated with the same pixel are forward biased (act 820).

For example, suppose that red, green and blue diodes 400 in row 2, columns 1-3, respectively, correspond to a single pixel of display 130. In this case, when that single pixel is to display information, display control logic 310 may forward bias the red and blue sub-pixels in row 2, columns 1 and 3 for the entire frame time T. Display control logic 310 may also forward bias the green diode in row 2, column 2 for a portion of the frame T, such as up to time t1 (as illustrated in FIG. 6B). At time t1, display control logic 310 may reverse bias the green diode 400 at row 2, column 2 so that the green diode 400 will act as a touch detector for this duration of time. The particular duration of time during which the green diode 400 is forward biased and reversed biased may vary. For example, as discussed previously, in one implementation, the period of time during which the green diode 400 may be forward biased may range from 50% to 80% of the total frame time T. Therefore, in this implementation, the period of time during which the green diode 400 may be reversed biased may range from 20% to 50% of the total frame time T. It should be understood that other durations of the overall frame time for forward and reverse biasing the green diodes 400 may also be used.

Display control logic 310 may then determine whether current (or voltage) is received via the green diode (act 830). That is, when the green diode 400 is biased with a negative voltage, if light is reflected back and falls incident upon green diode 400, the light may be detected by the green diode 400 and converted into a current (or voltage) by the green diode 400.

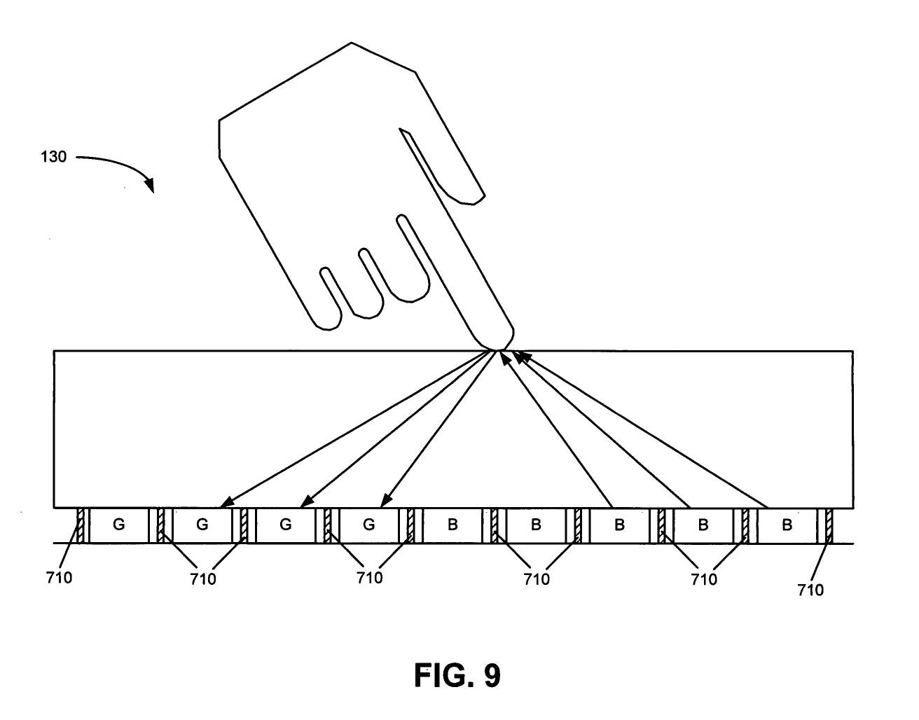

As an example, suppose that the user of mobile terminal 100 would like to enter a telephone number via keypad 136 of display 130. Further assume that the user touches a number on keypad 136, as illustrated in FIG. 9. In FIG. 9, only green and blue diodes/sub-pixels are illustrated for simplicity. Light emitted from one of more of the blue diodes (labeled B) may be reflected by the user's finger back to one or more of the green diodes (labeled G), as illustrated in FIG. 9. These green diodes, acting as photodiodes, may then convert the detected light into a current (or voltage). As discussed previously, red or blue diodes may be used in alternative embodiments to detect the reflected blue light. Display control logic 310 may receive the current from the green diode(s).

If display control logic 310 detects a current (or voltage) from display 130, display control logic 310 may then identify the location of the touch/input based on the particular diode(s) associated with the received current (act 840). For example, display control logic 310 may determine the row/column associated with the LED(s) that produced the current. Display control logic 310 may then determine that the user intended to provide an input via a particular visual element (e.g., a number on keypad 136, one of control buttons 134, etc.). Display control logic 310 may then process the input (act 850). For example, assume that the detected touch corresponded to a location in an area where the number 4 was displayed on keypad 136. In this case, display control logic 310 may display the number 4 in upper display 132.

As discussed above, in some implementation, display control logic 310 may determine whether the current (or voltage) meets a predetermined threshold. This threshold may be used to avoid false touch indications associated with incident light that may be received by the green diodes 400. That is, some incident light may fall upon the green diodes 400 and produce a small current. For example, prior to a finger or stylus (or some other object) actually contacting display 130, light may be reflected from the user's finger, stylus or other object located over display 130. The amount of light reflected back, however, may be scattered and only a small portion may fall on the green diodes 400. In this case, the resulting current or voltage generated by the green diode(s) 400 receiving the incident light may be relatively small. If the current is less than a threshold, this may indicate that current is not associated with a touch on display 130.

If no current is detected by display control logic at act 830 (or the current is less than a predetermined threshold), no input is detected and display control logic 310 may continue to bias and reverse bias the various diodes of display 130 based on the visual elements that are to be displayed.

In addition, as discussed above with respect to FIG. 6B, in some implementations, to compensate for potential loss in brightness associated with the green diodes 400 during the period in which the green diodes 400 are reverse biased, display control logic 310 may provide a higher driving voltage to the green diodes 400 than the driving voltage provided to other diodes. This higher driving voltage may compensate for any potential loss of brightness associated with the green diodes 400. Display control logic 310 may provide the appropriate driving voltages to the columns of display 130 on, for example, a row-by-row basis.

Display control logic 310 may also be used to detect multiple touches at different locations on display 130 that occur simultaneously or substantially simultaneously. For example, if a user touches two of his/her fingers at the same time at different locations on display 130, light reflected from the users' fingers will be detected by different ones of the green diodes 400. The green diodes 400 receiving the reflected light will then generate current or voltage. Display control logic 310 may then determine the locations or areas of the multiple touches on display 130 based on the addresses (e.g., row and column addresses) of the green diodes 400 generating the current or voltage. In this manner, a user may provide any number of touches simultaneously or substantially simultaneously and display control logic 310 will be able to detect and process the multiple touches/inputs.

Display control logic 310 may continue to operate to detect the user's inputs. In this manner, display 130 may act as a touch screen without providing additional elements/components on the surface of display 130. This prevents loss of front-of-screen performance and also allows display 130 to remain very thin.

As discussed above, blue light reflected from the user's finger/stylus may be detected by the green diodes 400. In some implementations, the blue light output by blue diodes 400 may be pulsed or modulated at a specific frequency. For example, blue diodes 400 may include a modulator configured to modulate and output blue light at a specific frequency or a relatively narrow sub-range of frequencies associated with blue light. Alternatively, a modulator located externally with respect to blue diodes 400 (e.g., in display control logic 310) may modulate or pulse the blue light with a specific frequency. The green diodes 400 acting as light detectors may correspondingly be configured to detect light in this specific frequency or narrow sub-range of blue light frequencies. In some instances, green diodes 400 may include logic to determine whether the incident blue light has the specific frequency or narrow sub-range of frequencies associated with the modulation. Alternatively, logic that is external to green diodes 400 (e.g., in display control logic 310) may be used to determine whether the incident blue light has the specific frequency or narrow sub-range of frequencies. In this manner, ambient light or noise received by the green diodes 400 that may be in the blue light frequency range will not be perceived as touches or inputs on display 130.

### Conclusion

Implementations described herein provide a display which acts as a touch screen display without providing additional components on the front of the display. Advantageously, this may enable the display to provide good front-of-screen performance and remain very thin. In addition, using the same components to alternately emit light and detect light may enable the display to operate as a touch screen without any significant increase in power requirements.

The foregoing description of the embodiments of the invention provides illustration and description, but is not intended to be exhaustive or to limit the invention to the precise form disclosed. Modifications and variations are possible in light of the above teachings or may be acquired from practice of the invention.

For example, aspects of the invention have been mainly described in the context of a mobile terminal. As discussed above, the invention may be used with any type of device that includes a display. In addition, aspects have been described with respect to a color display. In other implementations, a monochrome display may be used in a manner similar to that described above. Still further, various driving voltages and relative durations of forward biasing versus reverse biasing have been described. It should be understood that these values are exemplary only and other values or relative values may be used in alternative implementations.

Additionally, aspects of the invention have been described with respect to using LEDs as both emitters and detectors. It should be understood that other electronic and/or optical elements which have the functionality described above may be used in alternative implementations.

Further, while a series of acts have been described with respect to FIG. 8, the order of the acts may be varied in other implementations consistent with the invention. Moreover, non-dependent acts may be performed in parallel.

It will also be apparent to one of ordinary skill in the art that aspects described herein may be implemented in methods and/or computer program products. Accordingly, aspects of the invention may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain aspects described herein may be implemented as “logic” that performs one or more functions. This logic may include hardware, such as a processor, microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A device, comprising:
a display comprising a plurality of diodes; and
logic configured to:
forward bias a first one of the diodes for a first duration of time, the first duration of time corresponding to a frame,
forward bias a second one of the diodes for a first portion of the frame, and
reverse bias the second diode for a second portion of the frame, the second diode functioning as a touch detector during the second portion of the frame.

2. The device of claim 1, wherein the logic is further configured to:
receive, during the second portion of the frame, a current or voltage associated with the second diode, and
determine that a touch occurred based on the received current or voltage.

3. The device of claim 2, wherein the logic is further configured to:
determine a location on the display or a display element associated with the touch, and
process the input based on the location or display element.

4. The device of claim 1, wherein when forward biasing the first and second diodes, the logic is further configured to:
provide a first driving voltage to the first diode during the first duration of time, and
provide a second driving voltage to the second diode during the first portion of the frame, the second driving voltage being based on the relative duration of the first portion of the frame with respect to the second portion of the frame.

5. The device of claim 1, wherein when forward biasing the first and second diodes, the logic is further configured to:
provide a greater driving voltage to the second diode during the first portion of the frame than a driving voltage provided to the first diode during the first portion of the frame.

6. The device of claim 1, wherein the logic is further configured to:
detect multiple touches on the display that occur simultaneously or substantially simultaneously based on a received current or voltage associated with multiple ones of the plurality of diodes.

7. The device of claim 1, wherein the first diode and second diodes are associated with a single pixel of the display and wherein the first diode is configured to emit light have a first wavelength or range of wavelengths and the second diode is configured to detect light having the first wavelength or range of wavelengths.

8. The device of claim 7, wherein the first diode is a blue diode and the second diode is a green diode or red diode, the blue diode including a modulator configured to modulate emitted blue light to have a first frequency, and wherein the second diode is a red or green diode configured to detect blue light having the first frequency.

9. The device of claim 1, further comprising:
optical shielding disposed between at least the first and second diodes, the optical shielding preventing light emitted from the first diode from being directly received by the second diode.

10. The device of claim 1, wherein the plurality of diodes comprise organic light emitting diodes or polymer light emitting diodes.

11. The device of claim 1, wherein the device comprises a mobile telephone.

12. In a device comprising a display, a method comprising:
forward biasing a first one of a plurality of diodes associated with a first pixel in the display for a first duration of time;
forward biasing a second one of the diodes associated with the first pixel in the display for a second duration of time, the second duration of time being less than the first duration of time;
reverse biasing the second diode for a third duration of time, the third duration of time overlapping with the first duration of time;
detecting light by the second diode during the third duration of time; and
determining that a touch on the display occurred based on the detected light.

13. The method of claim 12, further comprising:
converting, by the second diode, the detected light into a current or voltage, wherein the determining that a touch occurred comprises:
determining that the touch occurred when the current or voltage is greater than a threshold.

14. The method of claim 12, further comprising:
determining a location on the display or a display element associated with the touch; and
processing the touch based on the location or display element.

15. The method of claim 12, wherein the forward biasing the second diode comprises forward biasing the second diode with a driving voltage based on the relative duration of the second duration of time with respect to the first duration of time.

16. The method of claim 12, wherein the forward biasing the first diode comprises forward biasing the first diode with a first voltage, and
the forwarding biasing the second diode comprises forward biasing the second diode with a second voltage, the second voltage being greater than the first voltage.

17. The method of claim 16, wherein the second voltage ranges from 10 percent to 50 percent greater than the first voltage, the particular percentage being based on the relative duration of the second duration of time with respect to the third duration of time.

18. The method of claim 12, further comprising:
modulating light emitted from the first diode to a first frequency, and wherein the detecting light by the second diode comprises:
detecting light having the first frequency.

19. The method of claim 12, further comprising:
providing optical shielding between at least the first and second diodes, the optical shielding preventing light emitted from the first diode from being directly received by the second diode.

20. The method of claim 12, further comprising:
detecting multiple touches on the display that occur simultaneously or substantially simultaneously based on a current or voltage associated with multiple ones of the plurality of diodes.

21. The method of claim 12, wherein the second duration of time is greater than or equal to the third duration of time.

22. A device, comprising:
display means comprising a first plurality of light emitting components and a second plurality of light emitting components, at least some of the second light emitting components functioning as both light emitting components and light detecting components;
control means for forwarding biasing at least some of the first plurality of light emitting components for a first period of time, forward biasing at least some of the second plurality of light emitting components for a second period of time and reverse biasing the at least some of the second plurality of light emitting components for a third period of time, the third period of time overlapping with the first period of time; and
input detection means for detecting a touch on the display means based on a current or voltage detected during the third period of time.

23. The device of claim 22, wherein the control means is configured to forward bias the at least some of second plurality of light emitting components with a higher driving voltage than the at least some of the first plurality of light emitting components, the higher driving voltage being based on a duration of the second period of time.

24. The device of claim 22, further comprising:
modulator means for modulating light emitted from the first plurality of light emitting components to a first frequency, the second plurality of light emitting components being configured to detect light having the first frequency.
